(19) United States
(12) Patent Application Publication
(10) Pub. No.: US 2025/0154723 A1
(43) Pub. Date: May 15, 2025

(54) INTERPENETRATING POLYMER NETWORK FOR PAPER AND PAPERBOARD COATING COMPOSITIONS

(71) Applicant: Buckman Laboratories International, Inc., Memphis, TN (US)

(72) Inventors: Samuel TEKOBO, Memphis, TN (US); Zhiyi ZHANG, Collierville, TN (US)

(73) Assignee: Buckman Laboratories International, Inc., Memphis, TN (US)

(21) Appl. No.: 18/925,076

(22) Filed: Oct. 24, 2024

Related U.S. Application Data
(60) Provisional application No. 63/548,231, filed on Nov. 13, 2023.

(51) Int. Cl. D21H 19/12; C09D 7/61; C09D 7/63; C09D 103/02; C09D 133/26

(52) U.S. Cl. CPC D21H 19/12; C09D 7/61; C09D 7/63; C09D 103/02; C09D 133/26

(57) ABSTRACT

An interpenetrating polymer network (IPN) is described, as well as coating compositions including a combination of a starch solution and the IPN for coating a paper or paperboard. The IPN includes a first copolymer of acrylamide and acrylic acid with a second copolymer of acrylamide and acrylic acid. The first copolymer and the second copolymer are different from each other at least with respect to average molecular weight. Processes of making the IPN and the coating composition as well as coating the paper or paperboard with the coating composition are also described.

### BACKGROUND OF THE INVENTION

This application claims the benefit under 35 U.S.C. § 119 (e) of prior U.S. Provisional Patent Application No. 63/548,231 filed Nov. 13, 2023, which is incorporated in its entirety by reference herein.

The present invention relates to polymers and their use in starch coating compositions for paper and paperboard. The present invention further relates to an interpenetrating polymer network (IPN) that can be added to starch to form a coating composition for paper and paperboard. The present invention further relates to methods of forming an IPN network that can be added to starch to form coating compositions for paper and paperboard.

Starch is commonly used in the papermaking industry for various purposes, including coating paper. Paper coating is the process of applying a thin layer of material onto the surface of paper to enhance its properties and performance. Starch can be used as a component in paper coatings for several reasons, such as improving strength, surface smoothness, printability, gloss and brightness, opacity, coating uniformity, and control of ink absorption.

In the paper industry, starch is often used in combination with other coating materials like binders, pigments, and additives to create coatings that meet the desired properties and performance characteristics for different types of paper, such as coated paper for printing, packaging, or specialty applications. A size press can be used to apply a coating to the paper's surface. The size press is typically located near the end of a paper making machine, after the paper has been formed and pressed but before it is wound into rolls. The size press is important for the production of coated papers, where a surface treatment or coating is applied to enhance the paper's properties.

Excessive use of starch in a coating composition can result in poor mechanical properties and high-water vapor permeability. To address this issue, certain synthetic polymers have been introduced to starch at the size press to reduce the concentration of starch used in the coating composition and for increasing paper strength. However, some synthetic polymers increase starch viscosity, causing deposits, runnability problems, and lowering paper strength.

Several processes have been proposed to improve strength of paper using coatings at the size press. One such method, described in U.S. Pat. No. 8,999,111B2, involves adding starch and a specific type of synthetic polymer together and cooking starch in a way that does not provide covalent bonding with starch. However, this method also leads to increased viscosity of the complex starch-polymer. Another method, described in EP0659780A1, involves producing amphoteric polyacrylamide with a molecular weight of 1500000 to 1000000. However, amphoteric polymers are generally not approved for size presses in the industry, and their high viscosity can create deposition on the size press machine, making it unsuitable for use in the paper-making process.

In view of the foregoing, improved polymers are needed that, in part, can address the one or more of the disadvantages discussed above. Particularly, it would be desirable to provide polymers that can be combined with a starch solution to form coatings that improve the strength of paper and yet maintain the viscosity of a starch solution. The present invention provides these solutions including providing methods and formulations to better address these problems.

### SUMMARY OF THE INVENTION

A feature of the present invention is to provide a polymer that can be used with a starch solution to form a coating composition for paper or paperboard.

Another feature of the present invention is to provide a polymer that when combined or mixed with a starch solution, substantially maintains the viscosity of the starch solution.

A further feature of the present invention is to provide a polymer that can be used with a starch solution to form a coating composition and provide an improvement in the strength of paper or paperboard when the coating composition is applied to the paper or paperboard.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages and in accordance with the purposes of the present invention, as embodied and broadly described herein, the present invention relates to an interpenetrating polymer network (IPN). The IPN includes a first copolymer that is the reaction product of a polymerizable composition comprising at least one acrylamide monomer and at least one acrylic acid monomer and a reactive prepolymer of acrylamide and acrylic acid. The IPN further includes a second copolymer that is the reaction product of a polymerizable composition comprising at least one acrylamide monomer and at least one acrylic acid monomer. The first copolymer and the second copolymer are different from each other at least with respect to average molecular weight.

As an option, the first copolymer has a first average molecular weight and the second copolymer has a second average molecular weight, and the first average molecular weight is at least 1.5 times higher than the second average molecular weight.

The present invention further relates to a coating composition that includes the IPN as part of a starch solution.

The present invention further relates to a paper or paperboard product that has a dry coating of the coating composition of the present invention, on at least a portion of the paper or paperboard.

Further, the present invention relates to a method of forming the IPN. The method includes: (i) polymerizing a first solution comprising an acrylamide monomer and acrylic acid monomer to obtain the reactive prepolymer; (ii) adding a second solution comprising an acrylamide monomer and acrylic acid monomer to the reactive prepolymer and polymerizing the second solution in the presence of the reactive prepolymer and terminating the reaction to obtain the first copolymer; and (iii) adding a third solution to the first copolymer and polymerizing the third solution in the presence of the first copolymer to form the second copolymer amongst the first copolymer. The first solution, second solution, and third solution have a total weight, and the first solution can be from 35% to 65 wt % of the total weight, the second solution can be from 10% to 40 wt % of the total weight, and the third solution can be from 10% to 40 wt % of the total weight. The first solution, second solution, and third solution can each further include sodium hydroxide. The polymerizing steps can be carried out by heating the solution and adding an initiator and sodium formate over a period of time. The first solution, second solution, and third solution can result from a single solution that is separated to obtain the first solution, second solution, and third solution.

It is to be understood that both the foregoing general description and the following detailed description are exemplary and explanatory only and are only intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF THE DRAWINGS

FIG. 1 is a bar graph showing a comparison of the viscosity of a corn starch solution and the viscosity of coating compositions including a combination of the corn starch solution and different percentages of an IPN of an embodiment of the present invention.

FIG. 2 is a bar graph showing a comparison of the viscosity of a corn starch solution (10-15%), the viscosity of a coating composition including a combination of the corn starch solution and different percentages of an IPN of an embodiment of the present invention, and a coating composition including a combination of the corn starch solution and different percentages of a commercial copolymer of acrylamide.

FIG. 3 is a bar graph showing a comparison of the viscosity of an ethoxylated starch solution (10%) and the viscosity of coating compositions including a combination of the ethoxylated starch solution and different percentages of an IPN of an embodiment of the present invention.

FIG. 4 is a bar graph showing a comparison of an average ring crush of a paper product with no coating, a paper product coated with a starch solution, paper products coated with a coating composition including a combination of the starch solution and different percentages of an IPN of an embodiment of the present invention, and paper products coated with a coating composition including a combination of the starch solution and different percentages of a commercial copolymer of acrylamide.

FIG. 5 is a line graph showing a comparison of a burst strength between a paper product without a coating, paper products coated with 3% by weight of a coating composition, and paper products coated with 6% by weight of the coating composition, the coating composition including a combination of a starch solution and different percentages of an IPN of an embodiment of the present invention.

FIG. 6 is a line graph showing a comparison of a compression strength between a paper product coated with a starch solution, paper products coated with 3% by weight of a coating composition, and paper products coated with 6% by weight of the coating composition, the coating composition including a combination of a starch solution and different percentages of an IPN of an embodiment of the present invention.

FIG. 7 is a line graph showing a comparison of ring crush between a paper product coated with a starch solution and paper products coated with 6% by weight of a coating composition, the coating composition including a combination of a starch solution and different percentages of an IPN of an embodiment of the present invention.

FIG. 8 is a bar graph showing a comparison of smoothness and porosity between a paper product without a coating, paper products coated with 3% by weight of a coating composition, and paper products coated with 6% by weight of the coating composition, the coating composition including a combination of a starch solution and different percentages of an IPN of an embodiment of the present invention.

FIG. 9 is a bar graph showing a comparison of a Cobb value between a paper product without a coating, paper products coated with a starch solution, and paper products coated with the coating composition including a combination of a starch solution and different percentages of an IPN of an embodiment of the present invention.

FIG. 10 is a bar graph showing a comparison of a percentage increase of ring crush between a paper product coated with a starch solution, paper products coated with a coating composition including a combination of the starch solution and different percentages of an IPN of an embodiment of the present invention, and paper products coated with a coating composition including a combination of the starch solution, different percentages of an IPN, and maleate fumarate rosin.

### DETAILED DESCRIPTION OF THE PRESENT INVENTION

The present invention relates to a composition and process for making an interpenetrating polymer network (IPN), a composition and process for making coating compositions include IPN combined with starch solutions, and paper or paperboard products that are coated with the coating compositions. The paper or paperboard products coated with the coating composition of the present invention can have improved compression and/or burst strength, while preferably maintaining optimal smoothness and/or absorption properties as compared to a coating composition that includes only starch and water and does not include a polymer added to the coating composition.

As used herein, the term “paper” includes all grades of paper and paperboard. The term “polymer” as used herein refers to a large molecule (macromolecule) composed of repeating structural units, monomers or monomeric units, connected by covalent chemical bonds. The term “copolymer” as used herein refers to a type of polymer including two or more different types of monomers chemically bonded together in a repeating pattern.

The term “acrylamide monomers” as used herein refers to any organic compound containing the acrylamide functional group, which includes a vinyl group (CH₂═CH—) and an amide group (—CONH₂). As an option, one or both of the bonds to the nitrogen for the amide group can be substituted. For instance, the amide group can be —CON(R¹)(R²) where either R¹ or R² or both can be H, an alkyl group (such as a C1, C2, C3, C4, C5, or C6 alkyl group). The alkyl group can be substituted. The alkyl group can be unsubstituted. Examples of the acrylamide monomer include acrylamide, N-methyl acrylamide, N-ethyl acrylamide, N-butyl acrylamide, N-dimethyl acrylamide, and/or maleic acid.

The term “acrylic acid monomers” as used herein refers to any organic compound containing the acrylic functional group, which includes a vinyl group (CH₂═CH—) linked to a carbonyl group (—CO—).

The term “interpenetrating polymer network” (IPN) as used herein describes a material comprising two or more different polymer or copolymer networks which are at least partially interlaced on a molecular scale of size and dimensions but are not covalently bonded together.

For the purposes of the present invention, the IPN is a composite material of a network of a first copolymer and a network of a second copolymer that are physically entangled or interlocked with one another, rather than chemically bonded. Each network of the first copolymer and the second copolymer maintains its own chemical identity and structure within the IPN. The IPN structure results in a material that combines the properties of each of the network of the first copolymer and the network of the second copolymer.

The first copolymer and the second copolymer preferably do not crosslink with each other. Preferably, any crosslinking, if occurring, is undetectable or essentially undetectable.

The IPN can be a sequential interpenetrating polymer network, in which the first copolymer is formed first, and then the second copolymer is subsequently synthesized or introduced within the structure of the first copolymer.

The IPN can be a sequential semi-interpenetrating polymer network, in which the first copolymer or the second copolymer is cross-linked while the other of the first copolymer and the second copolymer is not. This results in a structure where one of the copolymers forms a continuous network (the cross-linked copolymer) while the other is dispersed as a copolymer phase within the network.

The IPN can be combined (e.g., dispersed within, mixed with, or otherwise combined) with a starch solution to form a coating composition. Due to the properties of the IPN, an interaction between starch and the copolymers of the IPN in the coating composition are increased while simultaneously maintaining a low and stable viscosity of the coating composition. The IPN preferably spreads evenly along the starch matrices without affecting the starch viscosity. For example, the IPN of the present application can have less chain entanglement with the starch as compared to other acrylamide and acrylic acid copolymers and thus can have significantly less or no bulk intertwining chains, which can result in a higher fluidity of the IPN.

The first copolymer of the IPN is the reaction product of a polymerizable composition including at least one acrylamide monomer and at least one acrylic acid monomer and a reactive prepolymer of acrylamide and acrylic acid. The reactive prepolymer is a reaction product of a polymerizable composition of an acrylamide monomer and an acrylic acid monomer.

To generate the reactive prepolymer, a first solution including acrylamide monomers and acrylic acid monomers are polymerized. The first solution can be a polymerizable composition including at least one acrylamide monomer, at least one acrylic acid monomer, and optionally sodium hydroxide. The reactive prepolymer is the reaction product of the polymerized first solution. The reactive prepolymer formed has still has radical chains present and is considered reactive because the reactive prepolymer is capable of further propagation via the radical chains.

For purposes of the present invention, the reactive prepolymer can be considered a ‘living’ polymer as that term is understood in polymer chemistry.

The reactive prepolymer can have at least one of the following structures:

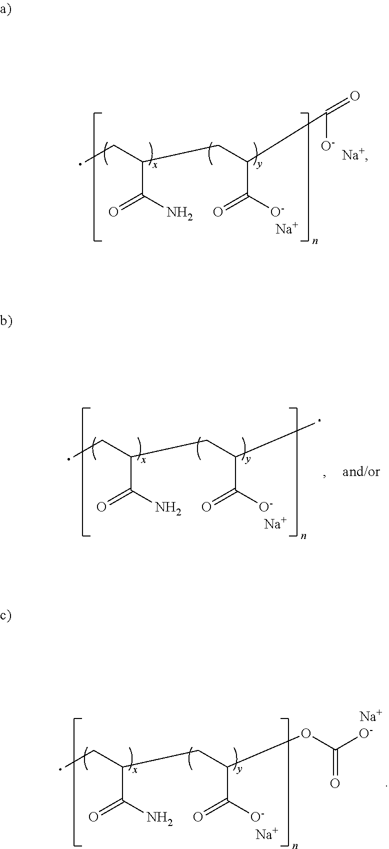

In the above structures, x/y is from 0.05 to 0.2, n is from 3 to 4000, and the “.” represents a radical or dangling covalent bond.

The reactive prepolymer shown in the above structures is a living polymer. The reactive prepolymer is considered a living polymer because the reactive prepolymer is capable of further propagation via the radical or dangling covalent bonds.

The reactive prepolymer can have a ratio of acrylamide to acrylic acid (x/y) of 0.05, 0.075, 0.1, 0.125, 0.15, 0.175, or 0.2 For example, the ratio of acrylamide to acrylic acid can be from 0.05 to 0.2, from 0.06 to 0.2, from 0.07 to 0.2, from 0.08 to 0.2, from 0.09 to 0.2, from 0.1 to 0.2, from 0.12 to 0.2, from 0.15 to 0.2, from 0.17 to 0.2, from 0.05 to 0.19, from 0.05 to 0.18, from 0.05 to 0.17, from 0.05 to 0.16, from 0.05 to 0.15, from 0.05 to 0.14, from 0.05 to 0.13, from 0.05 to 0.12, from 0.05 to 0.11, from 0.05 to 0.1 from 0.05 to 0.09, from 0.05 to 0.08, from 0.05 to 0.07, from 0.05 to 0.06, from 0.075 to 0.175, or from 0.1 to 0.15, or any range based upon any two values described herein.

The ‘n’ in the structures, which can be same or different when one than one structure is present, can be from 3 to 4000, from 5 to 4000, from 10 to 4000, from 20 to 4000, from 30 to 4000, from 50 to 4000, from 100 to 4000, from 200 to 4000, from 300 to 4000, from 400 to 4000, from 500 to 4000, from 750 to 4000, from 1000 to 4000, from 1250 to 4000, from 1500 to 4000, from 1750 to 4000, from 2000 to 4000, from 2250 to 4000, from 2500 to 4000, from 2750 to 4000, from 3000 to 4000, from 3250 to 4000, from 3500 to 4000, from 3750 to 4000, from 5 to 3750, from 5 to 3500, from 5 to 3250, from 5 to 3000, from 5 to 2750, from 5 to 2500, from 5 to 2250, from 5 to 2000, from 5 to 1750, from 5 to 1500, from 5 to 1250, from 5 to 1000, from 5 to 750, from 5 to 500, from 5 to 250, from 5 to 200, from 5 to 175, from 5 to 150, from 5 to 125, from 5 to 100, from 5 to 75, from 5 to 50, from 5 to 40, from 5 to 30, from 5 to 20, from 5 to 10, or any range based upon any two values described herein.

The first copolymer is then generated by combining a second solution with the reactive prepolymer (e.g., a solution containing the reactive prepolymer) and polymerizing the second solution in the presence of the reactive prepolymer. The second solution is a polymerizable composition that includes or comprises or consists of at least one acrylamide monomer, at least one acrylic acid monomer, and optionally sodium hydroxide. In other words, the first copolymer is formed by conducting a reaction of the polymerizable composition of the at least one acrylamide monomer, the at least one acrylic acid monomer, and the reactive prepolymer to obtain the first copolymer. The acrylamide monomers and acrylic acid monomers of the second solution propagate with one another and with the radical chains present in the reactive prepolymer. The polymerizing is then terminated to obtain the first copolymer.

The first copolymer can have at least one of the following structures:

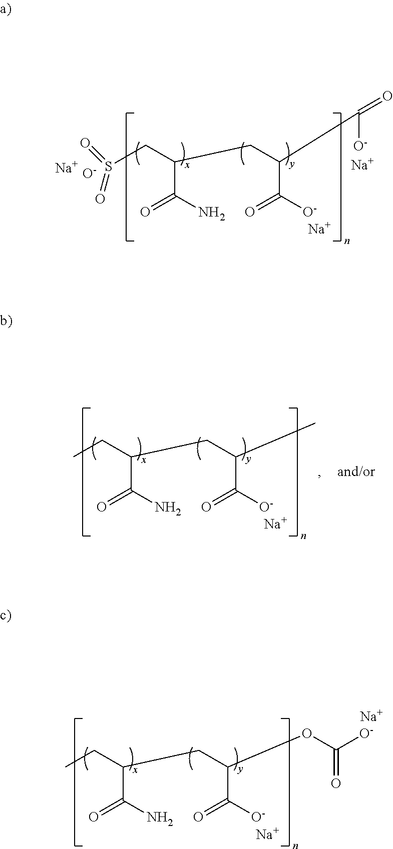

In these above structures, x/y is 0.05 to 0.2, n is from 300 to 5000, and the first copolymer is a dead polymer. The first copolymer is considered a dead polymer because the first polymer has terminal ends and is no longer capable of propagating.

The first copolymer can have a ratio of acrylamide to acrylic acid of 0.05, 0.075, 0.1, 0.125, 0.15, 0.175, or 0.2 For example, the ratio of acrylamide to acrylic acid can be from 0.05 to 0.2, from 0.06 to 0.2, from 0.07 to 0.2, from 0.08 to 0.2, from 0.09 to 0.2, from 0.1 to 0.2, from 0.12 to 0.2, from 0.15 to 0.2, from 0.17 to 0.2, from 0.05 to 0.19, from 0.05 to 0.18, from 0.05 to 0.17, from 0.05 to 0.16, from 0.05 to 0.15, from 0.05 to 0.14, from 0.05 to 0.13, from 0.05 to 0.12, from 0.05 to 0.11, from 0.05 to 0.1 from 0.05 to 0.09, from 0.05 to 0.08, from 0.05 to 0.07, from 0.05 to 0.06, from 0.075 to 0.175, or from 0.1 to 0.15, or any range based upon any two values described herein.

The ‘n’ in the structures, which can be same or different when one than one structure is present, can be from 300 to 5000, from 400 to 5000, from 500 to 5000, from 600 to 5000, from 700 to 5000, from 800 to 5000, from 900 to 5000, from 1000 to 5000, from 1250 to 5000, from 1500 to 5000, from 1750 to 5000, from 2000 to 5000, from 2250 to 5000, from 2500 to 5000, from 2750 to 5000, from 3000 to 5000, from 3250 to 5000, from 3500 to 5000, from 3750 to 5000, from 4000 to 5000, from 4250 to 5000, from 4500 to 5000, from 4750 to 5000, from 300 to 3750, from 300 to 3500, from 300 to 3250, from 300 to 3000, from 300 to 2750, from 300 to 2500, from 300 to 2250, from 300 to 2000, from 300 to 1750, from 300 to 1500, from 300 to 1250, from 300 to 1000, from 300 to 750, from 300 to 500, from 300 to 400, or any range based upon any two values described herein.

The second copolymer is formed by adding a third solution to the first copolymer and polymerizing the third solution in the presence of the first copolymer. The third solution is a polymerizable composition that includes or consists of at least one acrylamide monomer, at least one acrylic acid monomer, and optionally sodium hydroxide. The at least one acrylamide monomer and the at least one acrylic acid monomer of the third solution polymerize to form the second copolymer. This polymerization to form the second copolymer occurs in the presence of the first copolymer. The first copolymer does not polymerize or react with any of the monomer reactants that form the second copolymer.

The second copolymer can have at least one of the following structures:

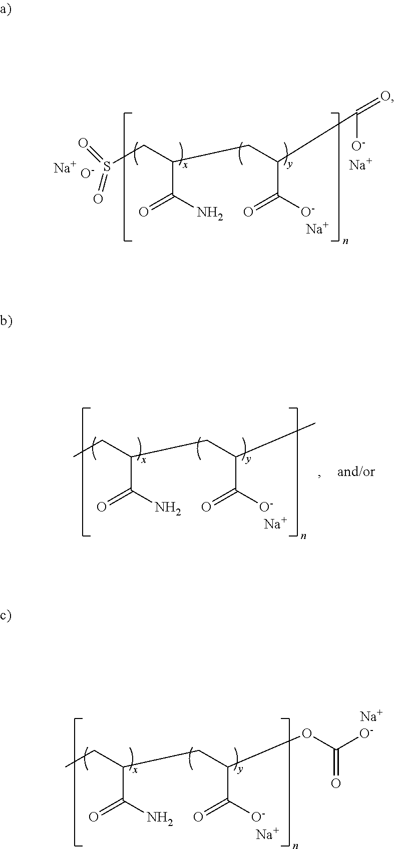

In the above structures for the second copolymer, x/y is 0.05 to 0.2, n is from 3 to 500, and the second copolymer is a dead polymer. The second copolymer is considered a dead polymer because the second copolymer has no radicals present and instead has terminal ends and thus is no longer capable of propagating.

The second copolymer can have a ratio of acrylamide to acrylic acid of 0.05, 0.075, 0.1, 0.125, 0.15, 0.175, or 0.2 For example, the ratio of acrylamide to acrylic acid can be from 0.05 to 0.2, from 0.06 to 0.2, from 0.07 to 0.2, from 0.08 to 0.2, from 0.09 to 0.2, from 0.1 to 0.2, from 0.12 to 0.2, from 0.15 to 0.2, from 0.17 to 0.2, from 0.05 to 0.19, from 0.05 to 0.18, from 0.05 to 0.17, from 0.05 to 0.16, from 0.05 to 0.15, from 0.05 to 0.14, from 0.05 to 0.13, from 0.05 to 0.12, from 0.05 to 0.11, from 0.05 to 0.1 from 0.05 to 0.09, from 0.05 to 0.08, from 0.05 to 0.07, from 0.05 to 0.06, from 0.075 to 0.175, or from 0.1 to 0.15, or any range based upon any two values described herein.

The ‘n’ in the second copolymer structures, which can be same or different when one than one structure is present, can be from 3 to 500, from 5 to 500, from 7 to 500, from 10 to 500, from 25 to 500, from 50 to 500, from 75 to 500, from 100 to 500, from 125 to 500, from 150 to 500, from 175 to 500, from 200 to 500, from 225 to 500, from 250 to 500, from 275 to 500, from 300 to 500, from 325 to 500, from 350 to 500, from 375 to 500, from 400 to 500, from 425 to 500, from 450 to 500, from 475 to 500, from 3 to 475, from 3 to 450, from 3 to 425, from 3 to 400, from 3 to 375, from 3 to 350, from 3 to 325, from 3 to 300, from 3 to 275, from 3 to 250, from 3 to 225, from 3 to 200, from 3 to 175, from 3 to 150, from 3 to 125, from 3 to 100, from 3 to 75, from 3 to 50, from 3 to 40, from 3 to 30, from 3 to 20, from 3 to 10, from 3 to 5, or any range based upon any two values described herein.

The IPN is further characterized by the first copolymer being different from the second copolymer at least with respect to average molecular weight. The average molecular weight is defined herein as the average mass of the molecule. The first copolymer has a first average molecular weight and the second copolymer has a second average molecular weight that is different from the first average molecular weight. The average molecular weight is determined by summing the weights of all the chains and then dividing by the total number of chains. The molecular weight can be characterized by one of three methods: weight average, Mw, number average, Mₙ, and Z average molecular weight. The average molecular weight reference herein can be any one of these three methods. Preferably, the average molecular weight is number average molecular weight. The molecular weight herein can be measured using many different methods including gel permeation chromatography (GPC), osmometry, light scattering, viscometry, cryoscopy, osmotic pressure method, ebulliometry, ultracentrifugation, mass spectrometry, and/or end-group analysis.

As an option, the first average molecular weight is higher than the second average molecular weight. As an example, the first average molecular weight is at least 1.5, 3, 4.5, 6, 7.5, 9, 10.5, 12, 13.5, or 15 times higher than the second average molecular weight. For example, the first average molecular weight can be from 1.5 times to 15 times, from 2 times to 15 times, from 3 times to 15 times, from 4 times to 15 times, from 5 times to 15 times, from 6 times to 15 times, from 7 times to 15 times, from 8 times to 15 times, from 9 times to 15 times, from 10 times to 15 times, from 11 times to 15 times, from 12 times to 15 times, from 13 times to 15 times, from 1.5 times to 14 times, from 1.5 times to 13 times, from 1.5 times to 12 times, from 1.5 times to 11 times, from 1.5 times to 10 times, from 1.5 times to 9 times, from 1.5 times from 8 times, from 1.5 times to 7 times, from 1.5 times to 6 times, from 1.5 times to 5 times, from 1.5 times to 4 times, from 1.5 times to 3 times, from 2 times to 10 times, from 3.5 times to 8 times, from 4 times to 6 times, higher than the second average molecular weight, or any range based upon any two values described herein.

As an option, the first copolymer is present in an amount of from 65% to 95% by weight of the total polymeric molecular weight of the IPN, such as from 65% to 90%, from 65% to 85%, from 65% to 80%, from 75% to 85%, from 65% to 75%, from 65% to 70%, from 70% to 95%, from 75% to 95%, from 80% to 95%, from 85% to 95%, from 90% to 95%, from 70% to 90%, from 75% to 90%, from 80% to 90% by weight of the total molecular weight of the IPN, or any range based upon any two values described herein.

As an option, the second copolymer is present in an amount of from 5% to 35% by weight of the total (polymeric) molecular weight of the IPN, such as from 5% to 30%, from 5% to 25%, from 5% to 20%, from 5% to 15%, from 5% to 10%, from 6% to 35%, from 7% to 35%, from 8% to 35%, from 9% to 35%, from 10% to 35%, from 15% to 35%, from 20% to 35%, from 25% to 35%, from 10% to 30%, or from 15% to 25%, by weight of the total molecular weight of the IPN, or any range based upon any two values described herein.

As an option, the first copolymer is present in an amount of from 65% to 95% by weight of the total polymeric molecular weight of the IPN, such as from 65% to 90%, from 65% to 85%, from 65% to 80%, from 65% to 75%, from 65% to 70%, from 70% to 95%, from 75% to 95%, from 75% to 85%, from 80% to 95%, from 85% to 95%, from 90% to 95%, from 70% to 90%, from 75% to 90%, from 80% to 90% by weight of the total molecular weight of the IPN, or any range based upon any two values described herein, and the second copolymer is present in an amount of from 5% to 35% by weight of the total (polymeric) molecular weight of the IPN, such as from 5% to 30%, from 5% to 25%, from 5% to 20%, from 5% to 15%, from 5% to 10%, from 6% to 35%, from 7% to 35%, from 8% to 35%, from 9% to 35%, from 10% to 35%, from 15% to 35%, from 20% to 35%, from 25% to 35%, from 10% to 30%, or from 15% to 25%, by weight of the total molecular weight of the IPN, or any range based upon any two values described herein.

For any of the copolymers or prepolymers, the acrylamide repeating units and the acrylic acid repeating units can be random in the polymer. The copolymers can be considered random copolymers.

As an option, for any of the copolymer and/or prepolymers, the acrylamide repeating units and the acrylic acid repeating units are the only monomer residues present.

The viscosity of the first copolymer is relatively low. In addition or alternatively, the viscosity of the IPN is relatively low.

When the IPN is combined with a starch solution to form a coating composition, the viscosity of the overall coating composition is the same or about the same (e.g., within 1%, within 2%, within 3%, within 4%, within 5%, within 10%) as the starch solution without the IPN or the coating composition has a marginally higher viscosity.

The viscosity of the solutions herein is measured using centipoise (cPS) at standard temperature and pressure (25 deg C. and 1 atm). Viscosity measurements can be carried out according to one of the five methods: the capillary viscometer, the flow cup, the rotational viscometer, the rolling ball viscometer and the drawing ball viscometer. A viscometer can be used, such as one from Elcometer, for instance, using device default settings. The viscosity can be a Brookfield viscosity at 25 deg C.

The first copolymer can have a viscosity of 250 cPS to 3000 cPS, such as from 250 cPS to 2750 cPS, from 250 cPS to 2500 cPS, from 250 cPS to 2250 cPS, from 250 cPS to 2000 cPS, from 250 cPS to 1750 cPS, from 250 cPS to 1500 cPS, from 250 cPS to 1250 cPS, from 250 cPS to 1000 cPS, from 250 cPS to 750 cPS, from 250 cPS to 500 cPS, from 250 cPS to 400 cPS, from 300 cPS to 4000 cPS, from 500 cPS to 4000 cPS, from 700 cPS to 4000 cPS, from 1000 cPS to 4000 cPS, from 1200 cPS to 4000 cPS, from 1400 cPS to 4000 cPS, from 1600 cPS to 4000 cPS, from 2000 cPS to 4000 cPS, from 2200 cPS to 4000 cPS, from 2400 cPS to 4000 cPS, from 2600 cPS to 4000 cPS, from 3000 cPS to 4000 cPS, from 3200 cPS to 4000 cPS, from 3400 cPS to 4000 cPS, from 3600 cPS to 4000 cPS, 500 cPS, 750 cPS, 1000 cPS, 1250 cPS, 1500 cPS, 2000 cPS, 2500 cPS, 3000 cPS, 3500 cPS, or 4000 cPS or any range based upon any two values described herein.

The IPN can have a viscosity of can have a viscosity of 250 cPS to 3000 cPS, such as from 250 cPS to 2750 cPS, from 250 cPS to 2500 cPS, from 250 cPS to 2250 cPS, from 250 cPS to 2000 cPS, from 250 cPS to 1750 cPS, from 250 cPS to 1500 cPS, from 250 cPS to 1250 cPS, from 250 cPS to 1000 cPS, from 250 cPS to 750 cPS, from 250 cPS to 500 cPS, from 250 cPS to 400 cPS, from 300 cPS to 4000 cPS, from 500 cPS to 4000 cPS, from 700 cPS to 4000 cPS, from 1000 cPS to 4000 cPS, from 1200 cPS to 4000 cPS, from 1400 cPS to 4000 cPS, from 1600 cPS to 4000 cPS, from 2000 cPS to 4000 cPS, from 2200 cPS to 4000 cPS, from 2400 cPS to 4000 cPS, from 2600 cPS to 4000 cPS, from 3000 cPS to 4000 cPS, from 3200 cPS to 4000 cPS, from 3400 cPS to 4000 cPS, from 3600 cPS to 4000 cPS, 500 cPS, 750 cPS, 1000 cPS, 1250 cPS, 1500 cPS, 2000 cPS, 2500 cPS, 3000 cPS, 3500 cPS, or 4000 cPS, or any range based upon any two values described herein.

The IPN can be in the form of a solution or dispersion. When in this state, the IPN can be considered an IPN solution or dispersion or can be considered a solution or dispersion comprising or including the IPN of the present invention. The solution or dispersion can have a solids content (or active solids content). The liquid component of the solution or dispersion can be or include water and/or aqueous liquids. The solids content can be from 20% to 40% solids content, such as from 22% to 40%, from 25% to 40%, from 28% to 40%, from 32% to 40%, from 35% to 40%, from 20% to 38%, from 20% to 35%, from 20% to 32%, from 26% to 32% or any range based upon any two values described herein. The % is a wt %. Total solids are measured by weighing the amount of solids present in a known volume of the sample.

A method of forming the IPN of the present invention can include the following. A first step can include polymerizing a first solution of acrylamide monomers and acrylic acid monomers to obtain the reactive prepolymer. A second step can include adding a second solution of acrylamide monomers and acrylic acid monomers to the reactive prepolymer and polymerizing the second solution in the presence of the reactive prepolymer. The reaction is then terminated to obtain the first copolymer. A third step can include adding a third solution of acrylamide monomers and acrylic acid monomers to the first copolymer and polymerizing the third solution in the presence of the first copolymer to form the second copolymer amongst the first copolymer.

With the method to form the IPN of the present invention and the various polymerization steps, besides the monomers that are polymerized, one or more initiators can be present, and/or one or more chain transfer agents can be present, and/or one or more other additives or agents useful in starting or promoting polymerizations or controlling polymerizations or controlling reaction conditions can be present.

The present application can alternatively or additionally be characterized by the mole percent of each reactant used in the methods to form the IPN of the present invention. For instance, the acrylic acid can be present as a reactant (and/or in the formed IPN) in an amount of from about 3 mole % to about 26 mole % (e.g., from 3 mole % to 22 mole %, from 3 mole % to 18 mole %, from 3 mole % to 15 mole %, from 3 mole % to 13 mole %, from 3 mole % to 10 mole %, from 3 mole % to 8 mole %, from 3 mole % to 6 mole %, from 3 mole % to mole %, from 4 mole % to 26 mole %, from 5 mole % to 26 mole %, from 7 mole % to 26 mole %, from 9 mole % to 26 mole %, from 12 mole % to 26 mole %, from 15 mole % to 26 mole %, from 18 mole % to 26 mole %, from 20 mole % to 26 mole %, from 22 mole % to 26 mole % or any range based upon any two values described herein). The acrylamide can be present as a reactant (and/or in the formed IPN) in an amount of from about 74 mole % to about 97 mole % (e.g., from 74 mole % to 95 mole %, from 74 mole % to 92 mole %, from 74 mole % to 90 mole %, from 74 mole % to 87 mole %, from 74 mole % to 85 mole %, from 74 mole % to 82 mole %, from 74 mole % to 80 mole %, from 74 mole % to 78 mole %, from 74 mole % to 76 mole %, from 76 mole % to 97 mole %, from 80 mole % to 97 mole %, from 83 mole % to 97 mole %, from 86 mole % to 97 mole %, from 89 mole % to 97 mole %, from 92 mole % to 97 mole %, from 94 mole % to 97 mole %, or any range based upon any two values described herein).

Throughout the polymerization process or through any segment of the polymerization process, ammonium persulfate can be introduced or fed into the reaction solution. This introduction can be during formation of the reactive prepolymer, during formation of the first copolymer, and/or during formation of the final IPN of the first copolymer and the second copolymer. The use of ammonium persulfate can be present for the entire reaction time, such as over a period of 6-7 hours, or at least 1 hour or at least 2 hours, or at least 3 hours, or at least 4 hours, or at least 5 hours, or at least 6 hours.

The multistep polymerization that involves in part prepolymers results in propagating sites of free radicals that are spread all across the reaction medium. It is believed that this assists in preventing an increase or significant increase in the IPN viscosity even if the concentration of the IPN is as high as 27% to 33% by weight in a solution or dispersion.

As an option, in the methods of the present invention, the total weight of the first solution that is used in the method of forming the IPN is greater than a total weight of the second solution that is used in the method.

As an option, the total weight of the first solution that is used in the method of forming the IPN can be greater than a total weight of the third solution that is used in the method. A total weight of the second solution and a total weight of the third solution that is used in the method of forming the IPN can be equal or substantially equal to one another, such as within 5%, 4%, 3%, 2%, 1% or 0.5% by weight of one other.

A total weight of the first solution that is used in the method of forming the IPN can be from 30% to 70% by weight of the total weight of the combined solutions (first, second, and third solutions). For example, the total weight of the first solution can be from 30% to 65%, from 30% to 60%, from 30% to 55%, from 30% to 50%, from 30% to 45%, from 30% to 40%, from 30% to 35%, from 35% to 70%, from 40% to 70%, from 45% to 70%, from 50% to 70%, from 55% to 70%, from 60% to 70%, from 65% to 70%, from 35% to 65%, from 40% to 60%, or from 45% to 55% by weight of the combined solutions, or any range based upon any two values described herein.

A total weight of the second solution that is used in the method of forming the IPN can be from 5% to 50% by weight of the total weight of the combined solutions. For example, the total weight of the second solution can be from 5% to 45%, from 5% to 40%, from 5% to 35%, from 5% to 30%, from 5% to 25%, from 5% to 20%, from 5% to 15%, from 5% to 10%, from 10% to 45%, from 15% to 45%, from 20% to 45%, from 25% from 45%, from 30% from 45%, from 35% to 45%, from 40% to 45%, from 10% to 40%, from 15% to 30%, or from 20% to 30% of the combined solutions or any range based upon any two values described herein.

A total weight of the third solution that is used in the method of forming the IPN can be 5% to 50% by weight of the total weight of the combined solutions. For example, the total weight of the third solution can be from 5% to 45%, from 5% to 40%, from 5% to 35%, from 5% to 30%, from 5% to 25%, from 5% to 20%, from 5% to 15%, from 5% to 10%, from 10% to 45%, from 10% to 40%, from 10% to 35%, from 10% to 30%, from 10% to 25%, from 10% to 20%, from 10% to 15%, from 10% to 40%, from 15% to 30%, or from 20% to 30% by weight of the combined solutions or any range based upon any two values described herein.

Each of the first solution, second solution, and third solution includes an acrylamide monomer and acrylic acid monomer.

As an option, each of the first solution, second solution, and third solution includes an acrylamide monomer and acrylic acid monomer as the only monomers present.

As an option, the first solution, the second solution, and/or the third solution further includes sodium hydroxide present.

The ratio of acrylamide to the acrylic acid monomers in the solutions can be as reflected in the structures and description associated with the structures (x and y and x/y). For example, the ratio of the acrylamide monomer to the acrylic acid monomer can be from 0.05 to 0.2, from 0.075 to 0.175, or from 0.1 to 0.15, or any range based upon any two values described herein.

The first solution, second solution, and third solution can be separate solutions. Alternatively, the first solution, second solution, and third solution can result from a single solution that is then separated to obtain a separate first solution, separate second solution, and separate third solution when performing the method of the present invention.

As an option, the first, second, and/or third solutions or the single solution can include acrylamide monomers, acrylic acid monomers, sodium hydroxide, and sodium formate.

Each of the first solution, second solution, third solution, or any combination of solutions can have a total weight of acrylic acid monomers of 4% by weight of the total weight of the respective solution. The total weight of the acrylic acid monomers can be from 1% to 15%, from 1% to 12%, from 1% to 10%, from 1% to 8%, from 1% to 6%, from 1% to 3%, from 1% to 2%, from 2% to 15%, from 4% to 15%, from 6% to 15%, from 8% to 15%, from 10% to 15%, from 12% to 15%, from 14% to 15%, from 2% to 14%, from 4% to 13%, from 6% to 11%, from 8% to 9% by weight of the respective solution or any range based upon any two values described herein.

Each of the first solution, second solution, third solution, or any combination of solutions can have a total weight of acrylamide monomers of 27% by weight of the total weight of the respective solution. The total weight of the acrylamide monomers can be from 10% to 40%, from 10% to 35%, from 10% to 30%, from 10% to 25%, from 10% to 20%, from 10% to 15%, from 10% to 12%, from 12% to 40%, from 16% to 40%, from 20% to 40%, from 24% to 40%, from 28% to 40%, from 32% to 40%, from 36% to 40%, from 12% to 38%, from 15% to 35%, from 20% to 30%, or from 22% to 24% by weight of the respective solution or any range based upon any two values described herein.

Each of the first solution, second solution, third solution, or any combination of solutions can have a total weight of sodium hydroxide of 4.43% by weight of the total weight of the respective solution. The total weight of the sodium hydroxide can be from 0.5% to 15%, from 0.5% to 12%, from 0.5% to 10%, from 0.5% to 8%, from 0.5% to 6%, from 0.5% to 4%, from 0.5% to 2%, from 1% to 15%, from 3% to 15%, from 5% to 15%, from 7% to 15%, from 9% to 15%, from 11% to 15%, from 1% to 14%, from 3% to 13%, from 5% to 11%, from 7% to 9% by weight of the respective solution or any range based upon any two values described herein.

Each of the first solution, second solution, third solution, or any combination of solutions can have a total weight of water of 66.5% by weight of the total weight of the respective solution. The total weight of the water can be from 30% to 80%, from 30% to 75%, from 30% to 65%, from 30% to 60%, from 30% to 55%, from 30% to 50%, from 30% to 45%, from 35% to 80%, from 40% to 80%, from 45% to 80%, from 50% to 80%, from 55% to 80%, from 35% to 75%, from 40% to 70%, from 45% to 65%, from 45% to 55%, from 50% to 52% by weight of the respective solution or any range based upon any two values described herein.

As a specific example, the percentage of acrylic acid monomer is 4%, the percentage of the acrylamide monomer is 27%, the percentage of the sodium hydroxide is 4.43%, and the percentage of the water is 66.5% by weight of the first solution, second solution, third solution, or any combination of solutions.

The concentration of monomers in any of the solutions (e.g., any one, any two, or all three solutions) referenced above can be from about 20% to 40% by weight based on the total weight of the respective solution. For example, the concentration of monomers in any one or two or all of the solutions can be from 20% to 40%, from 23% to 35%, from 27% to 33%, or 29% to 31% by weight based on total weight of the solution or any range based upon any two values described herein.

The pH of any one, any two, or all three of the solutions referenced above can be from about 7.5 to 12.5 pH. For example, the pH of the solutions can be from 7.5 to 12, from 8 to 12, from 8.5 to 11.5, from 9 to 11, or from 9.5 to 10.5 or any range based upon any two values described herein.

The total weight of sodium formate in any one, any two, or all three of the solutions referenced above can be from 0.005% to 0.15% by weight based on the total weight of the respective solution. The total weight of sodium formate in any one of the solutions can be from 0.005% to 0.03%, 0.01% to 0.025%, or 0.015% to 0.12% or any range based upon any two values described herein, by weight based on the total weight of the respective solution.

The polymerization step begins with an initiation step. This step involves the activation of an initiator molecule, which can be a chemical compound and/or a source of energy like heat or light. The initiation step can include heating the solution and adding an initiator and a chain transfer agent (e.g., sodium formate), such as over a period of time. Sodium formate is a chain transfer agent commonly used in such polymerizations. Potassium persulfate (KPS) and 2,2-azobisisobutyronitrile (AIBN) can be used as the initiator in solution, for example.

In the propagation step, monomer units add to the active site on the polymer chain, forming a new covalent bond between the monomer and the polymer chain. This process continues, with additional monomer units adding to the chain one at a time, leading to the elongation of the polymer chain. Termination can be initiated by the depletion of monomer units or the addition of specific terminating agents. Termination reactions halt the polymerization process, and the polymer chain stops growing.

In one or more embodiments, the polymerization steps can be carried out at an elevated temperature, such as from 67 deg C. to 80 deg C. (at 1 atm). For example, the polymerization steps can be carried out at a temperature of from 67 deg C. to 79 deg C., from 69 deg C. to 77 deg C., or from 71 deg C. to 75 deg C. or any range based upon any two values described herein.

As an option, the period of time of polymerization of the first step is 2 to 4 hours, such as 3 hours.

As an option, the second step can include adding the second solution to the reactive polymer continuously over a period of time, such as 30 minutes to 1.5 hours, such as 1 hour. As an option, the period of time of polymerization of the second solution in the presence of the reactive prepolymer is 2 to 3 hours, such as 2.5 hours.

As an option, the third step can include adding the third solution to the first copolymer continuously over a period of time, such as 15 minutes to 1 hour, such as 30 minutes. As an option, the period of time of polymerization of the third solution in the presence of the first copolymer is 2 to 3 hours, such as 2.5 hours.

The present invention further encompasses a coating composition including the IPN mixed or otherwise combined with a starch solution.

As an option, in the present invention, no amphoteric polymer(s) is present during the formation or after the IPN is formed.

As an option, in the present invention, no high molecular weight cationic polymer of acrylamide is present during the formation or after the IPN is formed. Examples of a high molecular weight (e.g., weight average MW) cationic polymer is 1.6 million Daltons to 6 million Daltons. Accordingly, a cationic polymer of acrylamide having a molecular weight of 1.6 million Daltons or more may not be present during the formation of after the IPN is formed.

As an option, in the present invention, no cationic polymer is present during the formation or after the IPN is formed.

Regarding the starch component, starch is typically stored and transported in a pre-cooked state, such that the pre-cooked starch is a white granular powder. This powder is largely insoluble in cold water because of its polymeric structure and because of hydrogen bonding between adjacent polymer chains. In order for it to be effective as a paper coating, water penetrates into the structure and thereby gelatinizes the starch into a form suitable for coating. In the absence of an energy input (such as vigorous stirring over a long period of time or added heat) the hydrogen bonding resists and impairs water penetration and gelatinization occurs either extremely slowly or not at all. When an aqueous suspension of pre-cooked starch is heated or cooked, the water is able to penetrate into the structures and swell up and gelatinize the starch. Heating and cooling of the now cooked starch can be performed to obtain a desired viscosity appropriate for applying the starch with a coating device. Typically, a starch composition is applied by a coating device when it has a low viscosity achieved by the composition being between 6-15 wt % starch and 85-94 wt % water.

As an option, the starch can be or includes natural starch, modified starch, amylose, amylopectin, styrene-starch, butadiene starch, starches containing various amounts of amylose and amylopectin, such as 25 wt % amylose and 75 wt % amylopectin (corn starch) and 20 wt % amylose and 80 wt % amylopectin (potato starch), enzymatically treated starches, hydrolyzed starches, ethoxylated starch, heated starches, also known in the art as “pasted starches”, cationic starches, such as those resulting from the reaction of a starch with a tertiary amine to form a quaternary ammonium salt; anionic starches, ampholytic starches (containing both cationic and anionic functionalities), cellulose and cellulose derived compounds, and any combination thereof and/or a combination thereof which explicitly excludes one or more of these.

In the present invention, an aqueous suspension of precooked starch and the IPN can be combined (e.g., mixed together) and then cooked (heated). The temperature for cooking is about 60 deg C. Other cooking temperatures can be used. When the IPN is mixed with precooked starch, the solution is recirculated in the tank at 60 deg C. and fed to the size press. As an alternative, the IPN can be added to an aqueous solution of cooked starch, for instance at a temperature of 60 deg C. or other temperature.

The IPN can be present, as part of the coating composition, in an amount of from about 5 wt % to about 25 wt % or more, based on the dry starch weight of the coating composition. For example, the IPN can be present in an amount of from about 5 wt % to about 25 wt %, from 10 wt % to 25 wt %, from 15 wt % to 25 wt %, from 20 wt % to 25 wt %, from 5 wt % to 20 wt %, from 5 wt % to 15 wt %, from 5 wt % to 10 wt %, or any range based upon any two values described herein.

In general, the term “about” can be defined as being the percentage listed or +1%.

To prepare the coating, the cooked starch solution can be heated to about 70 deg C. to 90 deg C., such as about 80 deg C. The IPN is then mixed with the heated starch solution and vigorously agitated to ensure proper mixing of the coating composition.

The coating composition can have a viscosity that is equal to or substantially equal to a viscosity of the cooked starch without the IPN. For example, the viscosity of the coating composition can be within 10%, 8%, 7%, 6%, 5%, 4%, 3%, 2%, 1%, 0.05%, 0.01%, or 0.001% of the viscosity of the cooked starch without the IPN present.

As an option, the coating composition can include a mixture of a starch solution, the IPN, and maleate fumarate rosin (B899). B899 can first be added to the heated starch solution at a concentration of from about 0.25% to 2% by weight, based on the total weight of the coating composition. For example, the B899 can be at a concentration of from 0.25% to 1.75%, from 0.35% to 1.5%, from 0.5% to 1.25%, or from 0.75% to 1.0% by weight. The IPN is then added to the starch and B899 solution and vigorously agitated, as described above.

When the coating composition is coated on paper, the paper preferably results in improved burst strength and/or ring crush. The increased burst strength is especially seen using the B899 in the coating composition along with the IPN of the present invention. The B899 may be contributing to the improved strength due to its competitive interaction with aluminum sulfate that is present in the cooked starch. This interaction is particularly prominent at low pH levels, such as a pH of 4.5 or lower, where the IPN has a tendency to bind with aluminum sulfate, thereby undermining the interaction between starch and the IPN.

The coating composition can include a chemical structure (4):

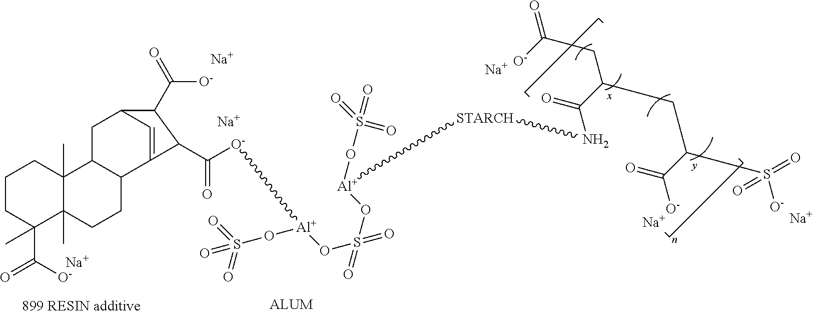

wherein n is from 20 to 4000 and x/y is 0.05 to 0.2.

The coating composition in the above structure can have a ratio of acrylamide to acrylic acid (x/y) of 0.05, 0.075, 0.1, 0.125, 0.15, 0.175, or 0.2 For example, the ratio of acrylamide to acrylic acid can be from 0.05 to 0.2, from 0.06 to 0.2, from 0.07 to 0.2, from 0.08 to 0.2, from 0.09 to 0.2, from 0.1 to 0.2, from 0.12 to 0.2, from 0.15 to 0.2, from 0.17 to 0.2, from 0.05 to 0.19, from 0.05 to 0.18, from 0.05 to 0.17, from 0.05 to 0.16, from 0.05 to 0.15, from 0.05 to 0.14, from 0.05 to 0.13, from 0.05 to 0.12, from 0.05 to 0.11, from 0.05 to 0.1 from 0.05 to 0.09, from 0.05 to 0.08, from 0.05 to 0.07, from 0.05 to 0.06, from 0.075 to 0.175, or from 0.1 to 0.15, or any range based upon any two values described herein.

The ‘n’ in the coating composition structure can be from 20 to 4000, from 25 to 4000, from 30 to 4000, from 40 to 4000, from 50 to 4000, from 60 to 4000, from 100 to 4000, from 200 to 4000, from 300 to 4000, from 400 to 4000, from 500 to 4000, from 750 to 4000, from 1000 to 4000, from 1250 to 4000, from 1500 to 4000, from 1750 to 4000, from 2000 to 4000, from 2250 to 4000, from 2500 to 4000, from 2750 to 4000, from 3000 to 4000, from 3250 to 4000, from 3500 to 4000, from 3750 to 4000, from 20 to 3750, from 20 to 3500, from 20 to 3250, from 20 to 3000, from 20 to 2750, from 20 to 2500, from 20 to 2250, from 20 to 2000, from 20 to 1750, from 20 to 1500, from 20 to 1250, from 20 to 1000, from 20 to 750, from 20 to 500, from 20 to 250, from 20 to 200, from 20 to 175, from 20 to 150, from 20 to 125, from 20 to 100, from 20 to 75, from 20 to 50, from 20 to 40, from 20 to 35, from 20 to 30, from 20 to 25, or any range based upon any two values described herein.

The above chemical structure shows the B899 binding with aluminum sulfate of the starch solution, and the starch binding with one of the first copolymers and the second copolymers of the IPN. As can be appreciated, starch molecules of the starch solution bind with the first copolymer and other starch molecules of the starch solution bind with the second copolymer within the coating composition.

As an option, the IPN is combined or mixed with the starch (e.g., precooked or cooked) and optionally the B899 onsite at the paper making facility, such as at the size press or a tank/feed to the size press. By mixing the IPN, starch solution, and B899 onsite, the coating composition can be more stable when applied to the paper by the size press. After mixing the IPN, starch solution, and B899, as described in detail above, the coating composition can be added to the size press.

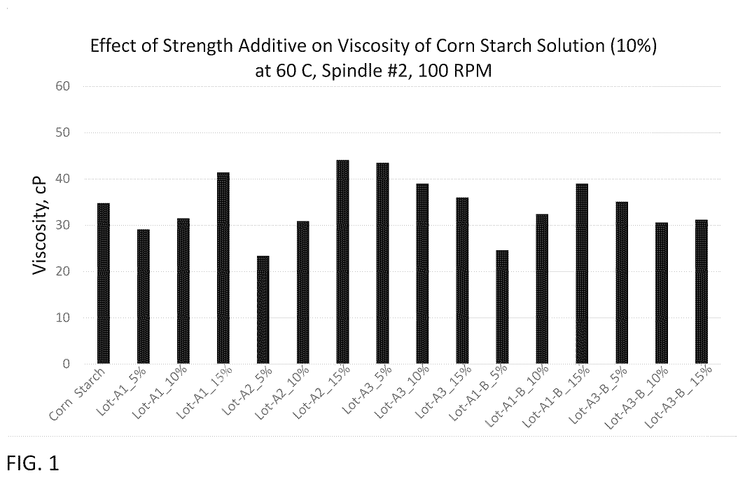

Referring to the Figures, FIG. 1 is a bar graph showing a comparison of the viscosity of a corn starch solution and the viscosity of a coating composition including a combination of the corn starch solution and an IPN of an embodiment of the present invention. The bar graph of FIG. 1 shows the viscosity of the corn starch solution containing 10% corn starch by weight and 90% water by weight compared to multiple lots or batches of the corn starch solution combined with the IPN of the present invention. The different lots include Lot-A1, Lot-A2, and Lot-A3. Each lot includes the corn starch solution combined with 5%, 10%, and 15% dry weight percentages of the IPN based on the dry starch weight. The bar graph further shows a combination of Lot-A1 and Lot-A3 with B899, which is shown as Lot-A1-B and Lot-A3-B, respectively. The viscosity of each solution is measured at 60 deg C. and using a spindle #2 and at 100 RPM (revolutions per minute) using a rotational viscometer. A rotational viscometer is an instrument that measures the resistance to flow of a fluid by rotating a spindle in the fluid at a known speed and measuring the torque required to overcome the fluid's resistance. Spindle #2 is one of the standard spindle choices available for use with rotational viscometers. As can be seen in FIG. 1, when compared with the corn starch solution (0% IPN), the viscosity of the different lots at different percentages of IPN is not substantially increased due to the addition of the IPN of the present invention, and in some cases, the viscosity is decreased as compared to the corn starch solution.

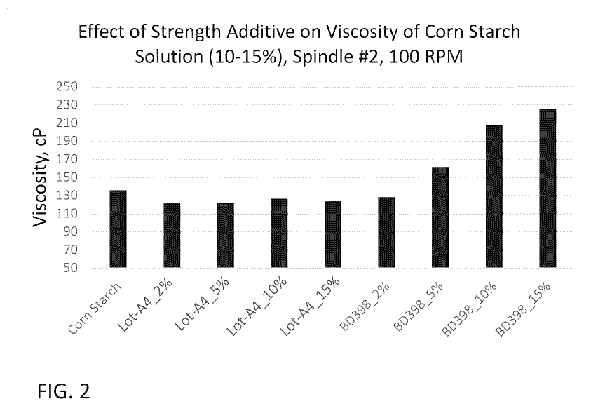

FIG. 2 is a bar graph showing a comparison of the viscosity of a corn starch solution (10-15%), the viscosity of a coating composition including a combination of the corn starch solution and different percentages of IPN of an embodiment of the present invention, and a coating composition including a combination of the corn starch solution and different percentages of a commercial copolymer of acrylamide. The bar graph of FIG. 2 shows the corn starch solution (0% IPN) that contains 10%-15% corn starch by weight and 85%-90% water by weight compared to Lot-A4 that is the corn starch solution combined with the IPN of the present invention. Lot-A4 includes 2%, 5%, 10%, and 15% dry weight percentages of the IPN based on the dry starch weight. The bar graph of FIG. 2 further shows BD398 that is the corn starch solution combined with a commercial copolymer of acrylamide (polyacrylamide co-acrylic acid). BD398 includes 2%, 5%, 10%, and 15% dry weight percentages of the commercial copolymer based on the dry starch weight. The viscosity of each solution is measured at 60 deg C. and using a spindle #2 and at 100 RPM using a rotational viscometer. The corn starch solution used for FIG. 2 was cooked to a higher viscosity as compared to the corn starch solution used for FIG. 1. As can be seen in FIG. 2, Lot-A4 has a similar viscosity as the corn starch solution for each of the percentages of IPN, while BD398 has a significant increase in viscosity as compared to the corn starch solution for each of the percentages of the commercial copolymer.

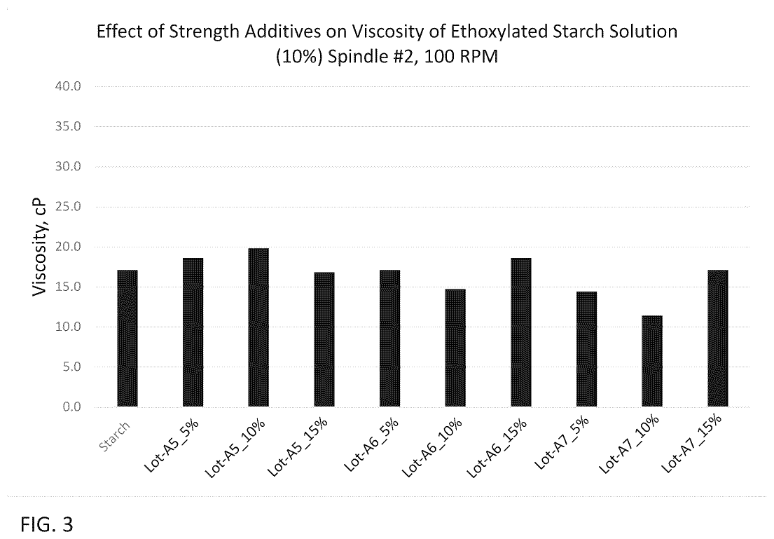

FIG. 3 is a bar graph showing a comparison of the viscosity of an ethoxylated starch solution (10% by weight) and the viscosity of a coating composition including a combination of the ethoxylated starch solution and different percentages of the IPN of the present invention. The bar graph of FIG. 3 shows the starch solution (0% IPN) that contains 10% ethoxylated starch by weight and 90% water by weight compared to multiple lots or batches of the ethoxylated starch solution combined with the IPN of the present invention. The different lots include Lot-A5, Lot-A6, and Lot-A7. Each lot includes 5%, 10%, and 15% dry weight percentages of the IPN based on the dry starch weight. The viscosity of each solution is measured at 60 deg C. and using a spindle #2 and at 100 RPM using a rotational viscometer. As can be seen in FIG. 3, when compared with the ethoxylated starch solution, the viscosity of the different lots is not substantially increased due to the addition of the IPN of the present invention, and in some cases, the viscosity is decreased as compared to the ethoxylated starch solution.

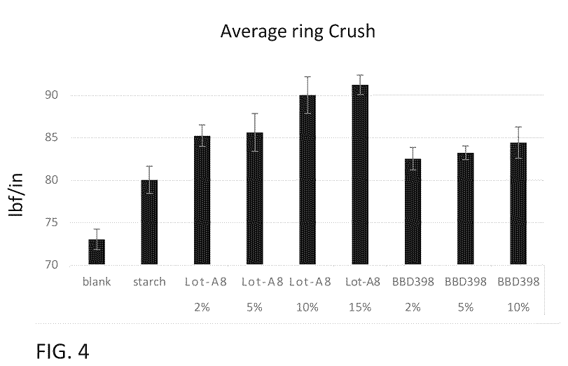

FIG. 4 is a bar graph showing a comparison of an average ring crush of a paper product with no coating, a paper product coated with a starch solution (0% IPN), paper products coated with coating compositions including a combination of the starch solution and different percentages of an IPN of the present invention (Lot-A8), and a paper product coated with a coating composition including a combination of the starch solution and different percentages of a commercial copolymer of acrylamide (BBD398). The average ring crush is determined by TAPPI T818 Ring Crush method. Lot-A8 includes 2%, 5%, 10%, and 15% dry weight percentages of the IPN based on the dry starch weight. BBD398 includes 2%, 5%, and 10% dry weight percentages of the commercial copolymer based on the dry starch weight. As can be seen in FIG. 4, the paper product coated with Lot-A8 has the highest average ring crush as compared to the paper product with no coating, the paper product coated with starch solution, and the paper product coated with BBD398. The bar graph demonstrates that the average ring crush of a paper product coated with the starch and IPN coating can increase by 1% to 15%, such as from 5% to 10%, as compared a paper product coated by a starch solution and a paper product coated with a starch solution and commercial copolymers.

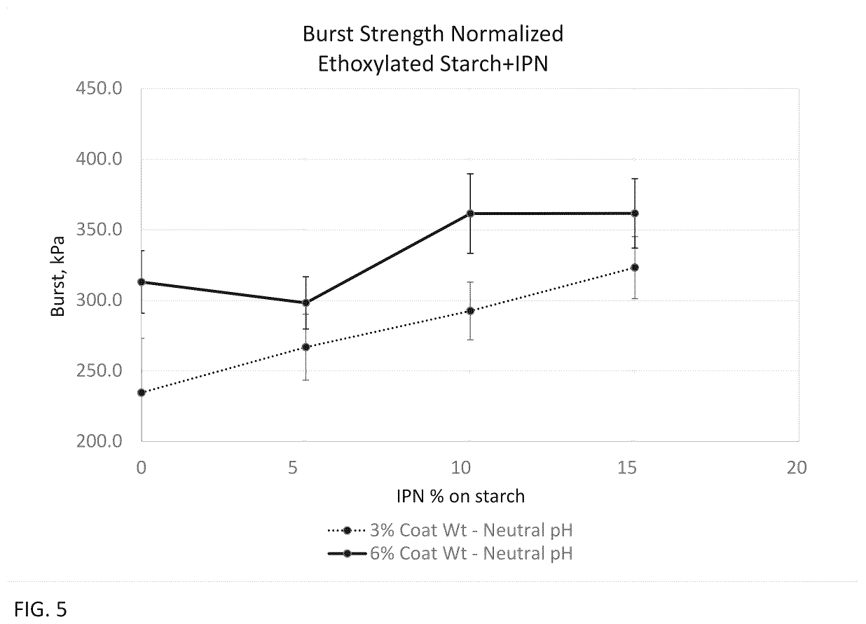

FIG. 5 is a line graph showing a comparison of a burst strength between paper products coated with 3% by weight of the respective coating based on the weight of the total paper product and coating, and paper products coated with 6% by weight of the respective coating based on the weight of the total paper product and coating. The paper products have different coatings including an ethoxylated starch solution (0% IPN) as well as combinations of an ethoxylated starch solution and 5%, 10%, and 15% dry weight percentages of the IPN based on the dry starch weight. The average Burst Strength is determined by TAPPI T403 Bursting method and measured as kPa. As shown in FIG. 5, the burst strength of the paper product coated with the coating composition (5%, 10%, and 15% IPN) of the present invention can increase from 1% to 15%, such as from 5% to 10% as compared to the coating with the ethoxylated starch solution (0% IPN).

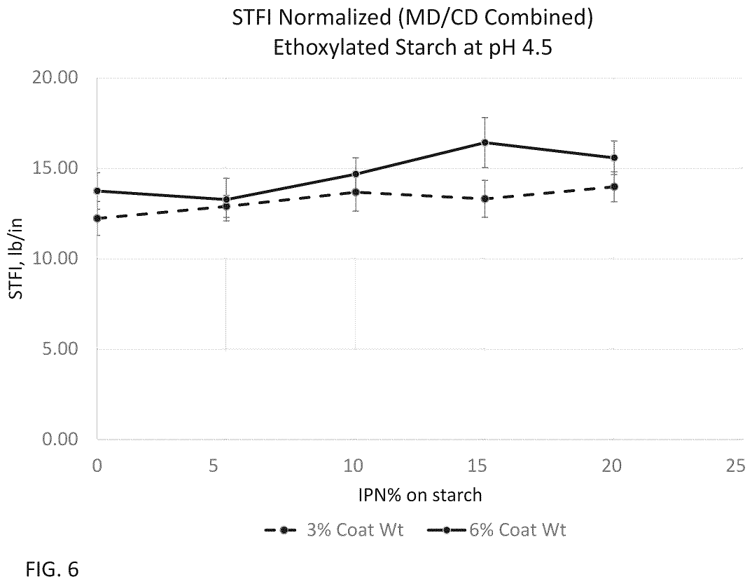

FIG. 6 is a line graph showing a comparison of a compression strength between paper products coated with 3% by weight of the respective coating based on the weight of the total paper product and coating, and paper products coated with 6% by weight of the respective coating based on the weight of the total paper product and coating. The paper products have different coatings including an ethoxylated starch solution (0% IPN) as well as combinations of an ethoxylated starch solution and 5%, 10%, 15%, and 20% dry weight percentages of the IPN based on the dry starch weight. The STFI is a measurement of the compression strength of linerboard measured as lb/in. MD/CD Combined indicates that measurements are taken in both the machine direction (MD) and the cross-direction (CD) of the paper sample, and the results have been combined. As shown in FIG. 6, the compression strength of the paper product coated with the coating composition (5%, 10%, 15%, and 20% IPN) of the present invention can increase up to 19.44% as compared to coating with the ethoxylated starch solution (0% IPN).

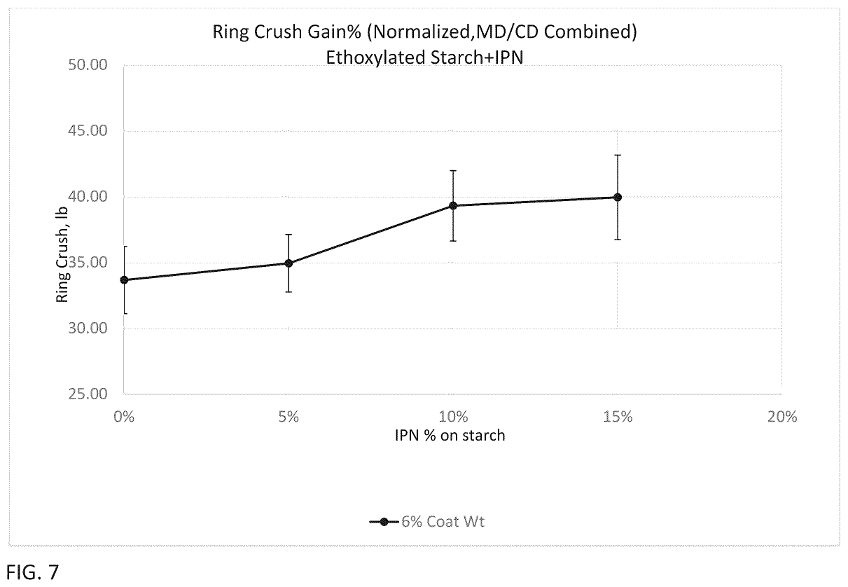

FIG. 7 is a line graph showing a comparison of a ring crush between paper products coated with 6% by weight of the respective coating based on the weight of the total paper product and coating. The paper products have different coatings including an ethoxylated starch solution (0% IPN) as well as combinations of an ethoxylated starch solution and 5%, 10%, and 15% dry weight percentages of the IPN based on the dry starch weight. MD/CD Combined indicates that measurements are taken in both the machine direction (MD) and the cross-direction (CD) of the paper sample, and the results have been combined. As shown in FIG. 7, the ring crush of the paper product coated with the coating composition (5%, 10%, and 15% IPN) of the present invention is increased as compared to coating with the ethoxylated starch solution (0% IPN).

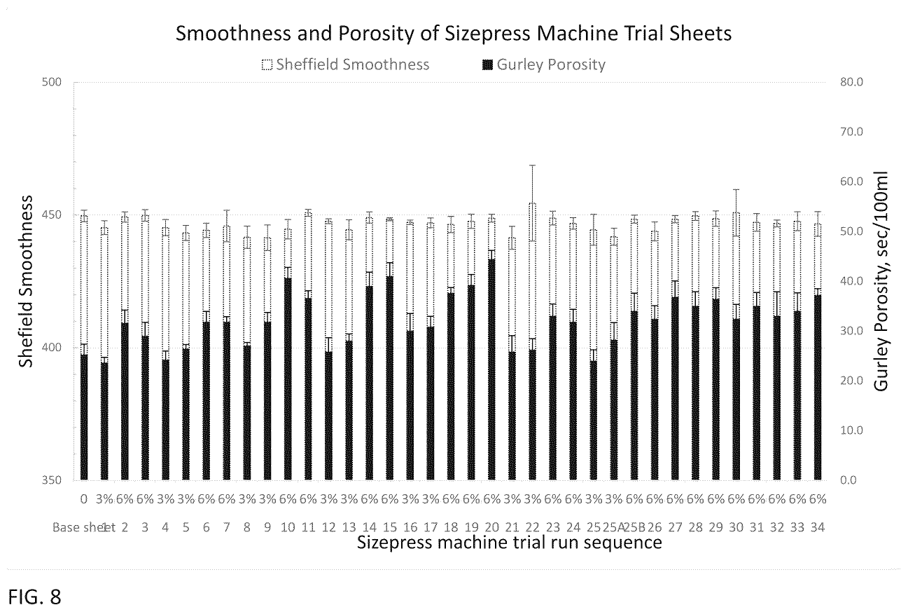

FIG. 8 is a bar graph showing a comparison of smoothness and porosity between a paper product without a coating (base sheet), paper products coated with 3% by weight of a respective coating based on the weight of the total paper product and coating composition, and paper products coated with 6% by weight of a respective coating based on the weight of the total paper product and coating composition. Thirty-four sheets were run on a paper machine and the Shefield smoothness (SU) and Gurley porosity (sec/100 mL) are provided in FIG. 8. Table 1 provided below corresponds to the thirty-four sheets provided in FIG. 8. As can be seen in Table 1, Sheets 1 and 2 include paper products coated with 3% by weight of a coating of starch solution (0% IPN) and 6% by weight of a coating of starch solution (0% IPN), respectively. Sheets 3-24 and 26-24 are paper products coated with 3% by weight and 6% by weight of respective coatings that include combinations of the starch solution and 5%, 10%, or 15% dry weight percentages of the IPN based on the dry starch weight. Sheets 25, 25A, and 25B are paper products coated with 3% by weight and 6% by weight of respective coatings that include combinations of the starch solution and 15%, 20%, and 30% dry weight percentages of the IPN based on the dry starch weight.

TABLE 1

| | pick up at the | |
|---|---|---|
| | size press | |
| Base | machine | |
| sheet | 0 | IPN % |
| 1 | 3% | 0% |
| 2 | 6% | 0% |
| 3 | 6% | 5% |
| 4 | 3% | 5% |
| 5 | 3% | 10% |
| 6 | 6% | 10% |
| 7 | 6% | 15% |
| 8 | 3% | 15% |
| 9 | 3% | 0% |
| 10 | 6% | 0% |
| 11 | 6% | 5% |
| 12 | 3% | 5% |
| 13 | 3% | 10% |
| 14 | 6% | 10% |
| 15 | 6% | 15% |
| 16 | 3% | 15% |
| 17 | 3% | 0% |
| 18 | 6% | 0% |
| 19 | 6% | 5% |
| 20 | 6% | 5% |
| 21 | 3% | 5% |
| 22 | 3% | 10% |
| 23 | 6% | 10% |
| 24 | 6% | 15% |
| 25 | 3% | 15% |
| 25A | 3% | 20% |
| 25B | 6% | 30% |
| 26 | 6% | 0% |
| 27 | 6% | 5% |
| 28 | 6% | 10% |
| 29 | 6% | 15% |
| 30 | 6% | 0% |
| 31 | 6% | 5% |
| 32 | 6% | 10% |
| 33 | 6% | 15% |
| 34 | 6% | 15% |

The results provided in FIG. 8 show that the IPN does not affect the surface smoothness of the paper and that pores on the paper are closed as a result of the penetration of IPN and starch composition inside the sheet of the paper product. Furthermore, for the increased percentages of IPN in the coatings of 25A and 25B, there is no negative impact on the porosity and smoothness of the sheet. Furthermore, no deposits were found on the paper machine.

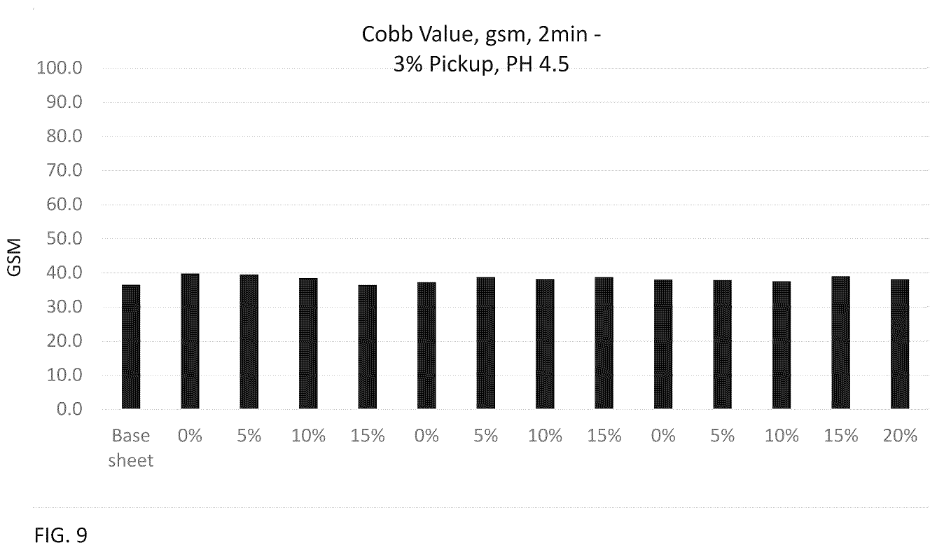

FIG. 9 is a bar graph showing a comparison of a Cobb value between a paper product without a coating (base sheet), a paper product coated with a starch solution (0% IPN), and paper products coated with the coating composition of the present invention. The coating composition includes a combination of the starch solution and 5%, 10%, and 15% dry weight percentages of the IPN of the present invention based on the dry starch weight. The Cobb value is a measure of the water absorbency of the paper product and is expressed in grams per square meter (g/m² or gsm) that indicates the amount of water a paper surface can absorb in a specific time frame. The “3% pickup” indicates that the paper has a water pickup of 3%. This means that when the paper is exposed to water, it absorbs an amount of water equal to 3% of its total weight. The paper products were at a pH of 4.5. As can be seen, the paper product with the coating composition of the present invention has a similar Cobb value as the base sheet and the paper product coated with the starch solution (0% IPN).

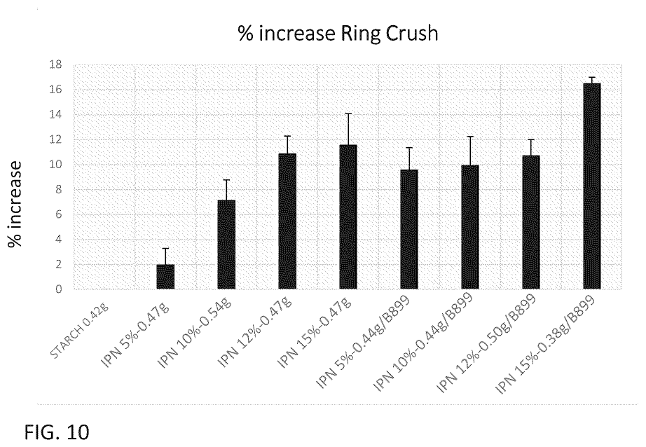

FIG. 10 is a bar graph showing a comparison of a percentage increase of ring crush between a paper product coated with a starch solution, paper products coated with a coating composition including a combination of the starch solution and 5%, 10%, 12%, and 15% dry weight percentages of the IPN of the present invention based on the dry starch weight, and a paper product coated with a coating composition including a combination of the starch solution, 5%, 10%, 12%, and 15% dry weight percentages of the IPN of the present invention based on the dry starch weight, and maleate fumarate rosin (B899). The grams shown in FIG. 10 represent the coating weight of the starch coating (0% IPN) and the starch and IPN coatings. The weight of the base sheet is weighed before and after applying the coating. The difference (provided in FIG. 10 as grams) is the amount of coating that has coated a surface of the sheet of around 93.5 in². As can be seen, the percentage of ring crush increased significantly for paper products having the coating with the IPN of the present invention, as compared to the paper product coated with the starch solution (0% IPN).

As demonstrated by the Figures, the coating composition with the IPN of the present invention increased strength of the coated paper products for both ethoxylated starch and enzymatic converted starch. The Figures demonstrate at least a 10%-20% increase in strength of the paper products that were coated with the coating composition of the present invention. Furthermore, the coating composition with the IPN had no detrimental runnability issues on pilot size press machines for all trial runs. The Figures further show that the coating composition with the IPN did not have a negative impact on sheet porosity, surface smoothness, surface friction, or sizing (Cobb test).

With the IPN present in the coating composition (and as compared to when no IPN is present but only starch), the following one or more improvements can be obtained).

The average Ring Crush (as determined by TAPPI T818 Ring Crush method) can increase from 1% to 15%, such as from 5% to 10% when IPN is present (such as present in an amount of from 5 to 15 wt % in the coating composition as compared to 0% IPN and 100% starch in a comparative coating solution).

The average Burst Strength (as determined by TAPPI T403 BUSTING METHOD method) can increase from 1% to 15%, such as from 5% to 10% when IPN is present (such as present in an amount of from 5 to 15 wt % in the coating composition as compared to 0% IPN and 100% starch in a comparative coating solution).

The STFI, which is a measurement of the compression strength of linerboard, can increase from 1% to 25%, such as from 5% to 20% or from 10% to 15% when IPN is present (such as present in an amount of from 5 to 15 wt % in the coating composition as compared to 0% IPN and 100% starch in a comparative coating solution).

Smoothness and porosity improvement were obtained with the present invention. As shown in the examples, the IPN polymer of the present invention did not negatively affect the surface smoothness of the paper and further the results show that the pores on the paper have been closed as a result of the penetration of IPN polymer and starch inside the sheet.

With respect to Cobb Value, additives can negatively impact the Cobb value. Meaning that some additives can decrease the hydrophobicity of the paper surface. With the present invention, the IPN did not cause an increase in the Cobb value. (When a Cobb value increases, this means that the surface is becoming more hydrophilic).

The present invention will be further clarified by the following examples, which are intended to be purely exemplary of the present invention, in which parts are proportions by weight unless otherwise specified.

### EXAMPLES

### Example 1: Preparation of Inventive IPN

A single solution of acrylamide monomers (254 g of 50% acrylamide monomer, 3.8 g of acrylic acid monomer, and 20 g of sodium hydroxide) was prepared. The concentration of total monomers was 27 wt % to 33 wt % of the single solution. The single solution had a pH of from 8.5 and 11.5. A reactor containing 2459 g of water was heated to 50° C. to 90° C. A first solution including 50 wt % of the single solution (total weight of the single solution was 6180 g) was fed to the reactor over a period of 80 minutes. An initiator (sodium persulfate 0.3-0.7% of the total batch volume and sodium formate 0.02-0.15% of the total batch volume) was fed to the reactor over a period of 7 hours total. After 2 hours of the polymerization of the first solution, a second solution including 25 wt % of the single solution was fed over a period of 60 minutes and the reaction was held for 2.5 hours. Afterwards, a third solution, including the remaining 25 wt % of the single solution was added over a period of 30 minutes and the reaction was held for additional 2.5 hours and an IPN was obtained that included a first copolymer physically intertwined with a second copolymer.

### Example 2: Preparation of Cooked Starch in Solution

250 grams of unmodified dry corn starch was added to a 3000 mL vessel followed by the addition of distilled water to reach 2000 total grams. The mixture was heated to an internal temperature of 70° C. with consistent stirring throughout the process. Once the mixture reached a temperature of 68° C. to 70° C., the mixture thickened significantly. Three drops of amylase were added and the mixture was then stirred for 20 minutes. Then, 3 ml of bleach was added dropwise to the mixture, which denatured the enzymes and stopped further hydrolysis of the starch.

### Example 3: Preparation of Coating Composition

The starch solution of Example 2 was added to individual glass jars and placed in a heated water bath set to 80° C. Starch solutions were allowed to equilibrate to testing temperature for thirty minutes to an hour. Individual jars were removed and immediately treated with the selected dose of the IPN of Example 1 (for the purpose of these experiments the dosages chosen were 5 wt %, 10 wt %, and 15 wt % IPN based on dry starch weight accounting for IPN solids). The amount of IPN is based on dry weight of the IPN. The jars were then vigorously agitated to ensure proper mixing of the coating composition before being used in the coating process. The viscosity of the coating composition was taken. FIGS. 1-3 are bar graphs showing the results of the viscosity measurements.

### Example 4: Coating Paper with the Coating Composition

Coating of the paper was performed using a #30 Jr. Laboratory Precision Drawdown Rod (ACCU-LAB) on 8.5″×11″ 23 #unsized brown paper with the aid of a TQC Automatic Film Applicator Compact. Samples were coated at 70 mm/s, allowed to air dry for one minute, and followed by heat setting on a flat dryer set to 105° C. All samples were placed in a conditioning chamber set to 24° C. and 50% relative humidity overnight prior to physical testing in compliance with TAPPI 402.

### Example 5: Testing of Coated Paper

The samples of Example 4 were tested for Ring Crush in compliance with TAPPI T 822 using a 0.010 center island and ½″×6″ strips prepared with a precision cutter. All data was reported in lbf and is reflected in the bar graph shown in FIG. 4. Coated samples were tested for Ring Crush, SFTI, and Cobb (see FIGS. 4, 6, 7, and 9) in compliance with TAPPI T 824 using ½″×6″ fluted strips. All data was reported in lb/in or lb as shown in the Figures. Coated samples were tested for Burst in compliance with TAPPI T 403. All data was reported in kPa and is reflected in the bar graph shown in FIG. 5. Coated samples were tested for Porosity in compliance with TAPPI 547 using rubber clamping plates with a 2.25-inch orifice diameter. All data was reported in Shelfield smoothness and Gurley porosity sec/100 ml and is reflected in the bar graph shown in FIG. 8. Coated samples were tested for STFI in compliance with TAPPI 494 using a 1″×4″ strip prepared with a precision cutter using a test speed of 25 mm/min. All data was reported in lb/in and are reflected in the bar graph shown in FIG. 6.

### Example 6: Preparation of Coating Composition Onsite

A concentration of 0.35 wt % to 1.5 wt % maleate fumarate rosin (B899) was added to a starch solution of Example 2 that contains 10%-15% corn starch and 85%-90% water. Then, the IPN of Example 1 was added to the starch solution at a concentration of 5 wt %, 10 wt %, and 15 wt % IPN based on dry starch weight. After circulation, the coating composition is added to the size press, which in turn applied the coating composition to the paper's surface.

### Example 7: Testing of Coated Paper with Coating Composition Prepared on Site

The samples of example 6 were tested for Ring Crush in compliance with TAPPIT 822 using a 0.010 center island and ½″×6″ strips prepared with a precision cutter. All data was reported in lbf and is reflected in the bar graph shown in FIG. 10.

The present invention includes the following aspects/embodiments/features in any order and/or in any combination:

The present invention in part relates to an interpenetrating polymer network (IPN) comprising a) a first copolymer that is the reaction product of i) a polymerizable composition comprising at least one acrylamide monomer and at least one acrylic acid monomer and ii) a reactive prepolymer of acrylamide and acrylic acid and b) a second co-polymer of at least acrylamide and acrylic acid, wherein the first copolymer and the second copolymer are different from each other at least with respect to average molecular weight.

The IPN of any preceding or following embodiment/feature/aspect, wherein the first copolymer has a first average molecular weight and the second copolymer has a second average molecular weight, and the first average molecular weight is at least 1.5 times higher than the second average molecular weight.

The IPN of any preceding or following embodiment/feature/aspect, wherein the first copolymer has a first average molecular weight and the second copolymer has a second average molecular weight, and the first average molecular weight is from 1.5 times to 15 times higher than the second average molecular weight.

The IPN of any preceding or following embodiment/feature/aspect, wherein the first copolymer has a first average molecular weight and the second copolymer has a second average molecular weight, and the first average molecular weight is from 2 times to 10 times higher than the second average molecular weight.

The IPN of any preceding or following embodiment/feature/aspect, wherein the first copolymer is present in an amount of from 70% to 90% by weight of the IPN, and the second copolymer is present in an amount of from 10% to 30% by weight of the IPN.

The IPN of any preceding or following embodiment/feature/aspect, wherein the first copolymer is present in an amount of from 75% to 85% by weight of the IPN, and the second copolymer is present in an amount of from 15% to 25% by weight of the IPN.

The IPN of any preceding or following embodiment/feature/aspect, wherein the IPN has a viscosity of from 250 cPS to 3000 cPS at 25 deg C. and 1 atm.

The IPN of any preceding or following embodiment/feature/aspect, wherein the first copolymer has a viscosity of from 250 cPS to 4000 cPS at 25 deg C. and 1 atm.

The IPN of any preceding or following embodiment/feature/aspect, wherein the IPN has a concentration of 26% to 32% of active solids.

The IPN of any preceding or following embodiment/feature/aspect, wherein the reactive prepolymer is a reaction product of a polymerizable composition comprising an acrylamide monomer, an acrylic acid monomer, and sodium hydroxide and the reactive prepolymer having radical chains present.

The IPN of any preceding or following embodiment/feature/aspect, wherein the reactive prepolymer has at least one of the following structures:

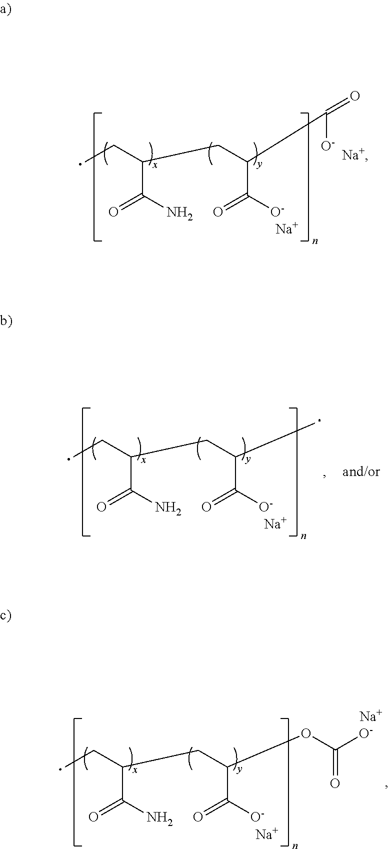

where x/y is from 0.05 to 0.2, and n is from 3 to 4000, and the “.” represents a radical or dangling covalent bond, and wherein the reactive prepolymer is a living polymer.

The IPN of any preceding or following embodiment/feature/aspect, wherein the first copolymer has at least one of the following structures:

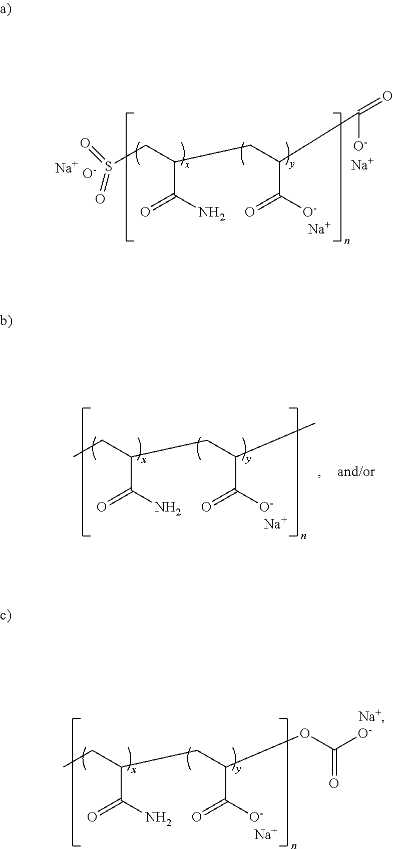

wherein x/y is 0.05 to 0.2, n is from 300 to 5000, and the first copolymer is a dead polymer.

The IPN of any preceding or following embodiment/feature/aspect, wherein the second copolymer has at least one of the following structures:

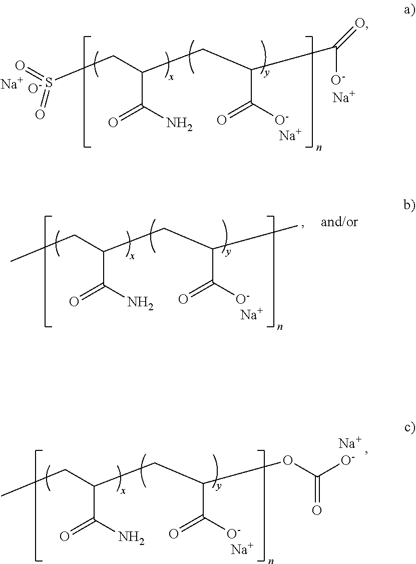

wherein x/y is 0.05 to 0.2, n is from 3 to 500, and the second copolymer is a dead polymer.

The IPN of any preceding or following embodiment/feature/aspect, wherein the IPN is a sequential interpenetrating polymer network or a sequential semi-interpenetrating polymer network.

A coating composition comprising the IPN of any preceding or following embodiment/feature/aspect, and a cooked starch solution.

The coating composition of any preceding or following embodiment/feature/aspect, wherein the IPN is present in an amount of from about 5 wt % to about 25 wt %, based on the dry starch weight of the coating composition.

The coating composition of any preceding or following embodiment/feature/aspect, wherein the coating composition comprises a chemical structure (4):

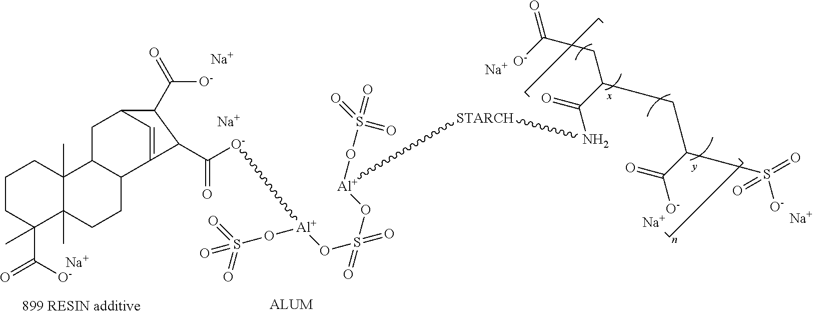

wherein n is from 20 to 4000 (e.g., or from 20 to 3750, or from 20 to 3500, or from 20 to 3250, or from 20 to 3000, or from 20 to 2750, or from 20 to 2500, or from 20 to 2250, or from 20 to 2000, or from 20 to 1750, or from 20 to 1500, or from 20 to 1250, or from 20 to 1000, or from 20 to 750, or from 20 to 500, or from 20 to 250, or from 20 to 200, or from 20 to 150, or from 20 to 100, or any range based upon any two values described herein).

The coating composition of any preceding or following embodiment/feature/aspect, wherein the viscosity of the coating composition is within 5% of the viscosity of the cooked starch solution.

The coating composition of any preceding or following embodiment/feature/aspect, wherein the viscosity of the coating composition is within 1% of the viscosity of the cooked starch solution.

A paper or paperboard product comprising paper or paperboard and a dry coating of the coating composition of any preceding or following embodiment/feature/aspect, on at least a portion of said paper or paperboard.

The present invention also in part relates to a method of forming the IPN of any preceding or following embodiment/feature/aspect, said method comprising (i) polymerizing a first solution comprising an acrylamide monomer and acrylic acid monomer to obtain the reactive prepolymer; (ii) adding a second solution comprising an acrylamide monomer and acrylic acid monomer to the reactive prepolymer and polymerizing the second solution in the presence of the reactive prepolymer and terminating the reaction to obtain the first copolymer; and (iii) adding a third solution to the first copolymer and polymerizing the third solution in the presence of the first copolymer to form the second copolymer amongst the first copolymer.

The method of any preceding or following embodiment/feature/aspect, wherein the first solution, second solution, and third solution have a total weight, and the first solution is from 35% to 65 wt % of the total weight, the second solution is from 10% to 40 wt % of the total weight, and the third solution is from 10% to 40 wt % of the total weight.

The method of any preceding or following embodiment/feature/aspect, wherein the first solution, second solution, and third solution each further comprise sodium hydroxide.

The method of any preceding or following embodiment/feature/aspect, wherein the polymerizing steps are carried out by heating the solution and adding an initiator and sodium formate over a period of time.

The method of any preceding or following embodiment/feature/aspect, wherein the first solution, second solution, and third solution result from a single solution that is separated to obtain the first solution, second solution, and third solution.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It will be apparent to those skilled in the art that various modifications and variations can be made to the embodiments of the present invention without departing from the spirit or scope of the present invention. Thus, it is intended that the present invention covers other modifications and variations of this invention provided they come within the scope of the appended claims and their equivalents.

What is claimed is:

1. An interpenetrating polymer network (IPN) comprising a) a first copolymer that is the reaction product of i) a polymerizable composition comprising at least one acrylamide monomer and at least one acrylic acid monomer and ii) a reactive prepolymer of acrylamide and acrylic acid and b) a second co-polymer of at least acrylamide and acrylic acid, wherein the first copolymer and the second copolymer are different from each other at least with respect to average molecular weight.

2. The IPN of claim 1, wherein the first copolymer has a first average molecular weight and the second copolymer has a second average molecular weight, and the first average molecular weight is at least 1.5 times higher than the second average molecular weight.

3. The IPN of claim 1, wherein the first copolymer has a first average molecular weight and the second copolymer has a second average molecular weight, and the first average molecular weight is from 1.5 times to 15 times higher than the second average molecular weight.

4. The IPN of claim 1, wherein the first copolymer has a first average molecular weight and the second copolymer has a second average molecular weight, and the first average molecular weight is from 2 times to 10 times higher than the second average molecular weight.

5. The IPN of claim 1, wherein the first copolymer is present in an amount of from 70% to 90% by weight of the IPN, and the second copolymer is present in an amount of from 10% to 30% by weight of the IPN.

6. The IPN of claim 1, wherein the first copolymer is present in an amount of from 75% to 85% by weight of the IPN, and the second copolymer is present in an amount of from 15% to 25% by weight of the IPN.

7. The IPN of claim 1, wherein the IPN has a viscosity of from 250 cPS to 3000 cPS at 25 deg C. and 1 atm.

8. The IPN of claim 1, wherein the first copolymer has a viscosity of from 250 cPS to 4000 cPS at 25 deg C. and 1 atm.

9. The IPN of claim 1, wherein the IPN has a concentration of 26% to 32% of active solids.

10. The IPN of claim 1, wherein the reactive prepolymer is a reaction product of a polymerizable composition comprising an acrylamide monomer, an acrylic acid monomer, and sodium hydroxide and the reactive prepolymer having radical chains present.

11. The IPN of claim 1, wherein the reactive prepolymer has at least one of the following structures: 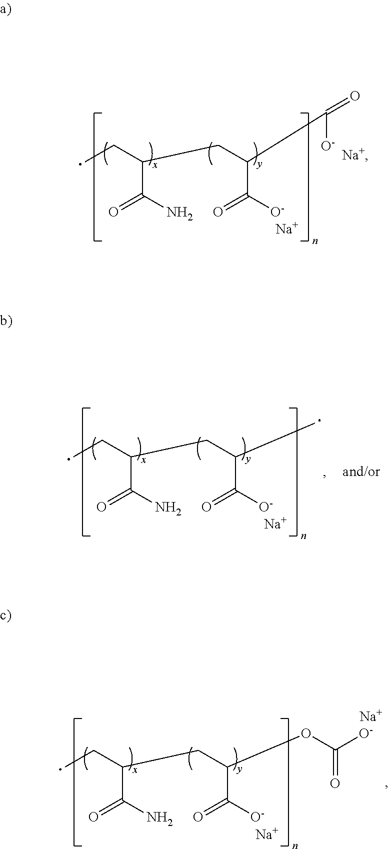
where x/y is from 0.05 to 0.2, and n is from 3 to 4000, and the “.” represents a radical or dangling covalent bond, and wherein the reactive prepolymer is a living polymer.

12. The IPN of claim 1, wherein the first copolymer has at least one of the following structures: 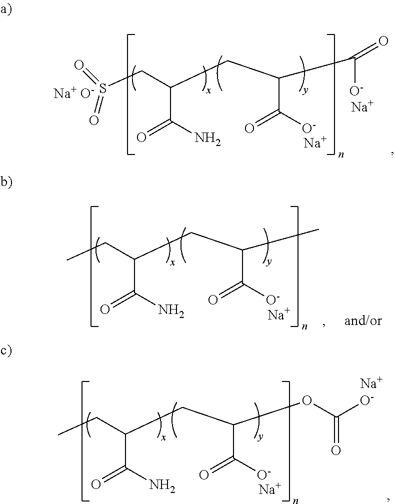
wherein x/y is 0.05 to 0.2, n is from 300 to 5000, and the first copolymer is a dead polymer.

13. The IPN of claim 1, wherein the second copolymer has at least one of the following structures: 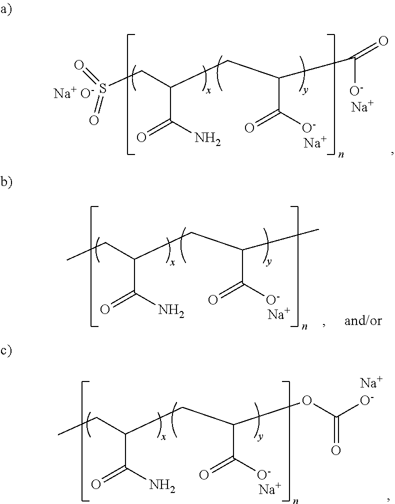
wherein x/y is 0.05 to 0.2, n is from 3 to 500, and the second copolymer is a dead polymer.

14. The IPN of claim 1, wherein the IPN is a sequential interpenetrating polymer network or a sequential semi-interpenetrating polymer network.

15. A coating composition comprising the IPN of claim 1 and a cooked starch solution.

16. The coating composition of claim 15, wherein the IPN is present in an amount of from about 5 wt % to about 25 wt %, based on the dry starch weight of the coating composition.

17. The coating composition of claim 15, wherein the coating composition comprises a chemical structure (4): 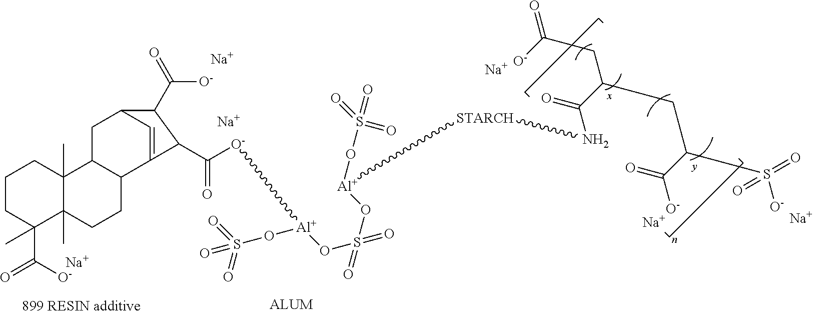
wherein n is from 20 to 4000.

18. The coating composition of claim 15, wherein the viscosity of the coating composition is within 5% of the viscosity of the cooked starch solution.

19. The coating composition of claim 15, wherein the viscosity of the coating composition is within 1% of the viscosity of the cooked starch solution.

20. A paper or paperboard product comprising paper or paperboard and a dry coating of the coating composition of claim 15 on at least a portion of said paper or paperboard.

21. A method of forming the IPN of claim 1, said method comprising
(i) polymerizing a first solution comprising an acrylamide monomer and acrylic acid monomer to obtain the reactive prepolymer; (ii) adding a second solution comprising an acrylamide monomer and acrylic acid monomer to the reactive prepolymer and polymerizing the second solution in the presence of the reactive prepolymer and terminating the reaction to obtain the first copolymer; and (iii) adding a third solution to the first copolymer and polymerizing the third solution in the presence of the first copolymer to form the second copolymer amongst the first copolymer.

22. The method of claim 21, wherein the first solution, second solution, and third solution have a total weight, and the first solution is from 35% to 65 wt % of the total weight, the second solution is from 10% to 40 wt % of the total weight, and the third solution is from 10% to 40 wt % of the total weight.

23. The method of claim 21, wherein the first solution, second solution, and third solution each further comprise sodium hydroxide.

24. The method of claim 21, wherein the polymerizing steps are carried out by heating the solution and adding an initiator and sodium formate over a period of time.

25. The method of claim 21, wherein the first solution, second solution, and third solution result from a single solution that is separated to obtain the first solution, second solution, and third solution.
